(19) United States
(12) Patent Application Publication
(10) Pub. No.: US 2010/0011253 A1
(43) Pub. Date: Jan. 14, 2010

(54) Circuit Arrangement for monitoring errors during signal transmission

(76) Inventors: Christian Wenzel-Benner, Biedenhopf (DE); Markus Bartel, Abstatt (DE); Thomas Kahnert, Hemmingen (DE); Peter Sautter, Lauffen (DE); Carsten Gebauer, Boeblingen (DE); Harald Tschentscher, Grossbottwar (DE); Berthold Fehrenbacher, Markgroeningen (DE); Achim Schaefer, Grossbottwar (DE); Gotthilf Koerner, Weissach (DE); Andreas Frey, Wessling (DE); Helmut Binder, Neckarsulm (DE); Bernd Stoehr, Sachsenheim (DE)

Correspondence Address: KENYON & KENYON LLP, ONE BROADWAY, NEW YORK, NY, 10004, US

(21) Appl. No.: 12/308,240

(22) PCT Filed: Sep. 26, 2007
(86) PCT No.: PCT/EP2007/060191

§ 371 Date: Sep. 22, 2009

(30) Foreign Application Priority Data
Oct. 6, 2006 (DE) 102006047396.5

(51) Int. Cl. G06F 11/30; H04L 29/04

(52) U.S. Cl. 714/43; 370/464; 714/E11.179

(57) ABSTRACT

A circuit arrangement, having a circuit and a computer unit is provided, in which the circuit and the computer unit are connected to one another via multiple lines for transmitting a number of signals which are embodied as information signals. The circuit has a multiplexer for combining signals, the multiplexer being connected to the computer unit via an additional line.

### BACKGROUND OF THE INVENTION

1. Field of the Invention

The present invention relates to a circuit arrangement which has a circuit and a computing unit, a control unit which has a circuit arrangement, a method for data processing, and a computer program product.

2. Description of Related Art

Within a control unit in automotive applications, rotational speed sensor signals are transmitted from an application-specific integrated circuit of the control unit or a similar system to a microcontroller (μC) and read in via timer inputs in the microcontroller. Since, for example, in ABS or ESP devices or systems the rotational speed sensor signals are relevant safety-related signals, it is necessary to detect a distortion of such signals in the microcontroller due to errors which may occur during the transmission and the analysis.

In this regard, it is provided in a dual-computer device that both computers read in and subsequently compare the same signals. In this way, all errors which occur during the analysis may be detected by the microcontroller. It is, however, not possible in this case to detect errors which occurred during transmission. The last-mentioned errors may be detected by a plausibility check of the normally four rotational speed sensor signals. Therefore it is still necessary to use two computers, which means doubling the costs.

In so-called single-computer devices or single-computer systems it is provided for monitoring a signal distortion to furnish an additional analyzing algorithm in the application-specific integrated circuit (ASIC) which converts the rotational speed sensor signals into a velocity and filters them. This makes it possible to detect all errors in the timer unit and during transmission. However, due to the different algorithms in the computer and the application-specific integrated circuit, a relatively long period of time is necessary for filtering as is a large tolerance for error detection in order to avoid error-related shut-downs. In addition, the system requires the analysis via the analyzing algorithm for which additional chip surface is needed on a chip of the application-specific integrated circuit.

A method and a device for data transmission are known from published German patent document DE 102 28 905. The serial data transmission takes place here between a first and a second user, the first user transmitting at least two signals from two signal paths unidirectionally to the second user. In addition, a shift register is provided in each user, two signal paths of the first user being guided in parallel into the shift register and the data transmission to the second user taking place by automatically timing the shift registers.

### BRIEF SUMMARY OF THE INVENTION

The present invention relates to a circuit arrangement which has a circuit and a computer unit. Within the circuit arrangement, the circuit and the computer unit are connected to one another via multiple lines for transmitting a number of signals which are embodied as information signals. In addition, the circuit has a multiplexer for combining signals, this multiplexer being connected to the computer unit via an additional line.

The present invention makes it possible to develop monitoring of a signal transmission and/or analysis in a computer unit and thus in a control unit. The circuit arrangement according to the present invention enables more accurate monitoring and considerably faster error detection and is more cost-effective than the aforementioned dual-computer or single-computer devices from the related art. In particular, compared to the single-computer devices, the errors may be detected faster and more precisely.

It may be provided that for each information signal to be transmitted the circuit and the computer unit are connected via one line. Thus, the circuit arrangement has a number of lines corresponding to the number of information signals. Furthermore, each line within the circuit is typically connected to a channel of the multiplexer via a branch line. Each signal embodied as an information signal may thus be transmitted via its own line from the circuit to the computer unit. In addition, each signal may be supplied to a channel of the multiplexer via the branch line, the information signals being combined in the multiplexer and transmitted together from the multiplexer via the additional line within the circuit to the computer unit, in particular to an input of the computer unit designed as a timer input or an analog input.

In an example embodiment of the present invention, it is provided that the multiplexer has additional channels which are provided for combining further signals. Such further signals may then be combined with the information signals and transmitted to the computer unit via the additional line.

In a further example embodiment, the circuit and the computer unit are additionally connected via a reference line for transmitting a signal embodied as a reference signal. This reference signal is also to be combined with the information signals via the multiplexer and transmitted to the computer unit via the additional line.

The control unit according to the present invention has at least one aforementioned circuit arrangement according to the present invention.

The present invention also relates to a method for processing signals. In this method, a number of signals, which are embodied as information signals, are transmitted between a circuit and a computer unit which are connected to one another via multiple lines. In this method, the signals are combined in a multiplexer of the circuit and transmitted to the computer unit via an additional line.

In one embodiment of the method, the signals are monitored for errors by the multiplexer and/or the timer input or the analog input. Errors occurring during a transmission or analysis may be detected using this method.

For this purpose, the signals, in particular the information signals, are combined by the multiplexer and transmitted via the additional line. In addition, at least one signal, embodied as a reference signal, and at least one further signal, in particular an information signal, may be combined by the multiplexer and transmitted to the computer unit via the additional line. It is also possible that a potential of the circuit, e.g., a reference voltage or ground, and at least one further signal, in particular one of the information signals, are combined by the multiplexer and transmitted via the additional line.

For monitoring and thus normally for controlling the method, the channels of the multiplexer are selected via a serial peripheral interface.

It is provided that at least one step or all steps of the method according to the present invention may be carried out by the control unit according to the present invention and/or the circuit arrangement according to the present invention. Moreover, individual functions of the circuit arrangement or of individual components of the circuit arrangement, normally of the circuit and the computer unit, may be considered as further steps of the method according to the present invention.

In one embodiment, information signals embodied as rotational speed sensor signals are transmitted to the computer unit embodied as a microcontroller (μC) by an application-specific integrated circuit (ASIC). Such rotational speed sensor signals are detected during operation on the typically four wheels of a motor vehicle by suitable sensors. This means a rotational speed sensor signal of the left front wheel (LFW), a rotational speed sensor signal of the rear right wheel (RRW), a rotational speed sensor signal of the front right wheel (FRW), and a rotational speed sensor signal of the rear left wheel (RLW). These information signals and thus rotational speed sensor signals are read in via inputs of a so-called timer in the microcontroller. Moreover, by implementing the present invention, the rotational speed sensor signals are supplied in individual channels of the multiplexer, combined and also transmitted to the microcontroller via the inputs of the timer. This makes it possible to detect a distortion of the information signals in the timer due to errors during transmission and analysis.

Furthermore, the present invention relates to a computer program having program code means for carrying out all steps of a method according to the present invention when the computer program is executed on a computer or an appropriate computer device, in particular in a control unit according to the present invention which has a circuit arrangement according to the present invention.

The computer program product according to the present invention having program code means, which are stored on a computer-readable data medium, is designed for carrying out all steps of a method according to the present invention when the computer program is executed on a computer or an appropriate computer device, in particular in a control unit according to the present invention which has a circuit arrangement according to the present invention.

It is understood that the aforementioned features and the features to be explained below are not only usable in the stated combination, but also in other combinations or as stand-alones without leaving the scope of the present invention.

### BRIEF DESCRIPTION OF THE DRAWING

FIG. 1 shows a schematic representation of an example embodiment of a control unit according to the present invention including an example embodiment of a circuit arrangement according to the present invention.

### DETAILED DESCRIPTION OF THE INVENTION

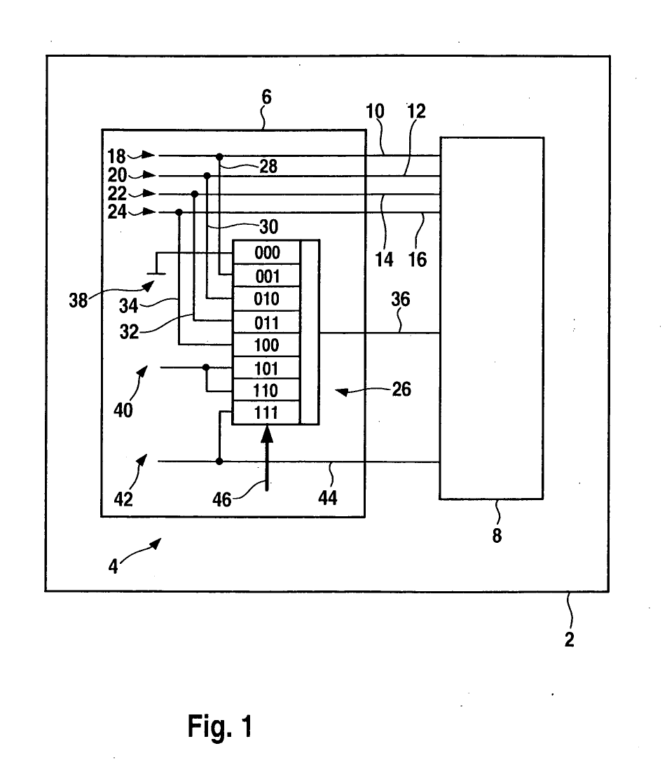

FIG. 1 shows a schematic representation of an example embodiment of a control unit 2 according to the present invention which includes an example embodiment of a circuit arrangement 4 according to the present invention. Circuit arrangement 4 in turn includes a circuit 6 and a computer unit 8 designed in the present example embodiment as a microcontroller. Circuit 6 is connected to inputs of a timer of computer unit 8 via four lines 10, 12, 14, 16 which are designed here as rotational speed sensor lines. From circuit 6, information signals 18, 20, 22, 24 are transmitted to computer unit 8 during operation of control unit 2 via these lines 10, 12, 14, 16. An information signal 18, which is detected on a front left wheel (FLW) of a vehicle, is transmitted via a first line 10. An information signal 20, which is detected on a rear right wheel (RRW) of a vehicle, is transmitted via a second line 12. A third information signal 22 for a front right wheel (FRW) of the vehicle is transmitted to computer unit 8 via a third line 14. Moreover, it is provided that a fourth information signal 24 of a rear left wheel (RLW) of the vehicle is transmitted via a fourth line 16.

Circuit 6 of circuit arrangement 4 has a multiplexer 26 which is designed in this example embodiment as a 3-bit multiplexer 26, individual channels of this multiplexer 26 being labeled with binary number combinations “000,” “001,” “010,” “011,” “100,” “101,” “110,” and “111.” A branch line 28, 30, 32, 34 is connected along each of lines 10, 12, 14, 16. It is thus possible to transmit first information signal 18 (FLW) to the channel labeled “001” of multiplexer 26 via a first branch line 28. Second information signal 20 is to be transmitted to the channel labeled “010” of multiplexer 26 via a second branch line 30. Similarly, third information signal 22 (FRW) is supplied to the channel labeled “011” of multiplexer 26 via a third branch line 32. Fourth information signal 24 (RLW) is transmitted to the channel labeled “100” of multiplexer 26 via the fourth branch line 34. Using the multiplexer, the four information signals 18, 20, 22, 24 embodied as rotational speed sensor signals are combined and transmitted to the timer, i.e., computer unit 8, via an additional line 36.

Therefore, it is possible to monitor and analyze the signals embodied here as information signals 18, 20, 22, 24 and to detect errors in information signals 18, 20, 22, 24.

The channel labeled “000” of multiplexer 26 is connected to ground 38 of circuit 6 via a transmission line. A potential 40 of circuit 6 is connected to the two channels labeled “101” and “110” of multiplexer 26 via additional transmission lines. In the present example embodiment, the potential has a voltage of 3.3 V. On the one hand, a signal, provided as reference signal 42, is to be transmitted to the channel labeled “111” of multiplexer 26 via a transmission line. On the other hand, a reference line 44 is provided via which this reference signal 42 is to be transmitted to computer unit 8. A serial peripheral interface 46 is provided for selecting one of channels “000,” “001,” “010,” “011” “100,” “101,” “110,” and “111.”

Using circuit arrangement 4 shown here, which has circuit 6 and computer unit 8, a number of signals, embodied here as information signals 18, 20, 22, 24, may be transmitted from circuit 6 to computer unit 8 via lines 10, 12, 14, 16. Moreover, these information signals 18, 20, 22, 24 may be combined via multiplexer 26 and transmitted to computer unit 8 via additional line 36.

Reference signal 42 makes it possible to very quickly-detect general errors in a timer which have an effect on all channels “000,” “001,” “010,” “011,” “100,” “101,” “110,” and “111.” Switching the individual information signals 18, 20, 22, 24 to additional line 36 via multiplexer 26 results in detection of channel-selective errors in the timer and on the transmission path of circuit arrangement 4 formed by lines 10, 12, 14, 16.

The particular channel “000, “ ”001,” “010,” “011,” “100,” “101,” “110,” and “111” is normally selected via the serial peripheral interface 46. Such a selection, however, is also conceivable in a different way.

1-15. (canceled)

16. A circuit arrangement, comprising:
a circuit and a computer unit connected to one another by multiple, parallel transmission lines transmitting multiple signals embodied as information signals, wherein the circuit includes a multiplexer connected to the computer unit via an additional line, the multiplexer combining at least some of the multiple signals and transmitting a resulting signal to the computer unit via the additional line.

17. The circuit arrangement as recited in claim 16, wherein each information signal is transmitted over a corresponding dedicated transmission line.

18. The circuit arrangement as recited in claim 17, wherein each transmission line is connected to one channel of the multiplexer via a corresponding dedicated branch line.

19. The circuit arrangement as recited in claim 18,
wherein the multiplexer has additional channels for additional signals.

20. The circuit arrangement as recited in claim 18, wherein the circuit and the computer unit are additionally connected to each other by a reference line for transmitting a signal embodied as a reference signal.

21. The circuit arrangement as recited in claim 18, wherein the circuit arrangement is incorporated in a control unit.

22. A method for processing signals, comprising:
transmitting multiple signals embodied as information signals over multiple, parallel transmission lines connected between a circuit and a computer unit; and
combining at least some of the multiple signals in a multiplexer of the circuit and transmitting a resulting signal to the computer unit via an additional transmission line which connects the multiplexer to the computer unit.

23. The method as recited in claim 22, further comprising:
monitoring the transmitted multiple signals for errors.

24. The method as recited in claim 24, wherein a reference signal and at least one additional signal are combined by the multiplexer and transmitted via the additional transmission line.

25. The method as recited in claim 24, wherein a potential of the circuit and at least one additional signal are combined by the multiplexer and transmitted via the additional transmission line.

26. The method as recited in claim 24, wherein the channels of the multiplexer are selected via a serial peripheral interface.

27. A computer-readable data storage medium storing a computer program having instruction codes which, when executed on a processor, controls a method for processing signals, the method comprising:
transmitting multiple signals embodied as information signals over multiple, parallel transmission lines connected between a circuit and a computer unit; and
combining at least some of the multiple signals in a multiplexer of the circuit and transmitting a resulting signal to the computer unit via an additional transmission line which connects the multiplexer to the computer unit.
